(19) United States
(12) Patent Application Publication
(10) Pub. No.: US 2022/0271367 A1
(43) Pub. Date: Aug. 25, 2022

(54) COOLING FRAME FOR A BATTERY CELL ARRANGEMENT

(71) Applicant: Mahle International GmbH, Stuttgart (DE)

(72) Inventor: Erik Person, Stuttgart (DE)

(21) Appl. No.: 17/676,103

(22) Filed: Feb. 18, 2022

(30) Foreign Application Priority Data
Feb. 19, 2021 (DE) 102021201596.4

(51) Int. Cl. H01M 10/6556; H01M 10/613; H01M 10/6555; H01M 50/204

(52) U.S. Cl. CPC H01M 10/6556; H01M 10/613; H01M 10/6555; H01M 50/204

(57) ABSTRACT

A cooling frame for a battery cell arrangement may include a cooling part. The cooling plate may include a channel structure that can be flowed through by a coolant. The channel structure may be formed by at least one cut-out.

### CROSS-REFERENCE TO RELATED APPLICATION

This application claims priority to German Patent Application No. DE 102021201596.4, filed on Feb. 19, 2021, the contents of which is hereby incorporated by reference in its entirety.

### TECHNICAL FIELD

The invention relates to a cooling frame for a battery cell arrangement and to a battery cell arrangement having at least one such cooling frame.

### BACKGROUND

Battery modules, which consist of multiple battery cells, are employed in particular in vehicles with electric drive in order to be able to store and provide the electric energy required for driving the electric machine of the vehicle when required. During the operation, the said battery cells typically generate waste heat that has to be removed in order to prevent damage to or even destruction of the battery cells due to overheating.

For cooling the battery cells it is known to arrange these stack-like next to or on top of one another and provide between the individual battery cells a cooling device each for cooling the battery cells. This can be a system of cooling channels through which a coolant is conducted which by way of heat transfer absorbs waste heat generated by the battery cells during the operation in this way discharging the same from the battery cells. However, realising conventional cooling devices configured in such a manner is technically complex since a preferably areal system of cooling channels have to be realised and the same have to be coupled to the battery cells in a thermally favourable manner. Here it has to be taken into account that the thermal expansion caused by the heating of the battery cells can lead to a so-called “bulging” of the battery cells—and accompanied by this to mechanical stresses—between the cooling device and the battery cells. This effect has to be compensated for by the cooling devices arranged between the battery cells.

It is therefore an object of the present invention to show new ways in the development of cooling devices for battery cells. In particular a cooling device—that is preferably producible cost-effectively—is to be created, which addresses the problem explained above.

### SUMMARY

Accordingly, the basic idea of the invention is to form a cooling device for cooling battery cells as cooling frame which is arranged between two adjacent battery cells of a stack of battery cells stacked on top of one another. Here, such a cooling frame is formed by a cooling plate in which a channel structure is formed, which in turn can be flowed through by a coolant, which by heat transfer can absorb waste heat from the battery cells.

The said channel structure according to the invention is formed by at least one cut-out provided in the cooling plate, along which the coolant can flow. Such a technically extremely simple construction of the cooling plate or of the cooling frame makes possible the desired compensation for the said “bulging” of the battery cells during heating. In particular, so-called “swelling forces” generated by the battery cells during the bulging can be compensated for. Because of the simple construction of the cooling frame the same can also be produced cost-effectively.

A cooling frame according to the invention for an arrangement of multiple battery cells— in the following also referred to as “battery cell arrangement”—includes a cooling plate, preferentially of a plastic, which comprises a channel structure that can be flowed through by a coolant. Here, the cooling structure is formed by at least one cut-out provided in the cooling plate. The coolant can flow along this cut-out when the cooling plate is arranged between two battery cells or their battery cell housing, so that these battery cells or their battery cell housing cover the cut-out on the top side and on the bottom side. Thus, the cut-out is practically formed covered towards the top side and towards the bottom side of the cooling plate so that the cut-out forms a coolant channel along which the coolant can flow. Obviously, two or more such cut-outs can also be provided in the cooling plate which are formed fluidically separated from one another or fluidically communicate with one another.

According to a preferred embodiment, the cooling frame includes a film each arranged, in particular attached to a top side and to a bottom side of the cooling plate, which both cover the channel structure on the top side and on the cooling side of the cooling plate respectively in a fluid-tight manner. In this way, a cooling frame is created with which an undesirable leakage of the coolant when flowing through the channel structure or the cut-out on the top side or bottom side of the cooling plate is prevented. Such a unit of cooling plate and films can also be arranged and installed without problems between the battery cells to be cooled or their battery cell housing. Preferably, the film material of the said films is a multi-composite film of plastic and of metal.

According to a preferred embodiment, the at least one cut-out for forming a coolant channel is formed longitudinally, extends along an extension direction and opens at a first extension end into a coolant inlet for conducting the coolant into the cut-out and at a second extension end into a coolant outlet for conducting the coolant out of the coolant channel. This characteristic makes possible a simple conducting of the coolant into the channel structure for flowing through the same and, having flowed through, also a conducting of the coolant out of the channel structure. The said coolant inlet and coolant outlet respectively can be easily fluidically connected to a suitable coolant reservoir or fluidically integrated in a cooling circuit, in which the coolant circulates.

According to an advantageous further development, a width of the longitudinal cut-out measured transversely to the extension direction amounts to a maximum of 6.5 mm, preferentially approximately 6.5 mm. In this manner it is ensured that the base plate, despite the presence of the channel structure or of the cut-out forming the channel structure, has a sufficiently high mechanical stiffness in order to avoid an undesirable plastic deformation of the material of the base plate during the occurrence of the said swelling forces.

Particularly practically, a plate thickness of the cooling plate in an outer edge zone of the cooling plate laterally delimiting the cooling plate on the outside is at least 0.5 mm greater than an inner zone of the cooling plate that is complementary to the edge zone. In this manner, preload forces, which during the construction or the mounting or the assembly of the battery cell arrangement of multiple battery cells and the cooling frame or cooling plates arranged in between act on the cooling frame, can be compensated for so that in particular no plastic deformation of the material of the base plate occurs. The said bulging can be compensated for particularly effectively in the inner zone. Preferably, the outer edge zone particularly preferably surrounds the inner edge zone completely.

According to another preferred embodiment, the at least one cut-out or the channel structure in a plan view of the cooling plate has a U-shaped or/and an S-shaped or/and a meandering contour. Also conceivable is a combination of the contour forms mentioned above in particular in portions. By means of the said contours it is ensured in each case that the base plate on the one hand can be areally flowed through by coolant so that an effective thermal coupling of the battery cells or their battery cell housing to be cooled to the coolant is ensured, while on the other hand it is likewise ensured that the swelling forces acting during the “bulging” can be particularly effectively absorbed and compensated for.

According to a further preferred embodiment, the at least one cut-out or the channel structure in a plan view of the cooling plate has a wavy contour at least in portions. A homogeneous flow of the coolant through the cooling plate and thus a homogeneous cooling of the battery cells or their battery cell housing arranged on the cooling frame and thermally connected to the coolant are also ensured in this way.

According to an advantageous further development, at least two cut-outs are arranged in the at least one cooling plate for forming a respective coolant channel, which with their first extension ends open into the coolant inlet and with their second extension ends into the coolant outlet. This measure also leads to an improved areal distribution of the coolant on the base plate and to an improved thermal coupling of the coolant to the battery cells or battery cell housing to be cooled.

According to a further advantageous further development, the coolant inlet and the coolant outlet are arranged on the same side of the cooling plate. Alternatively to this, the coolant inlet and the coolant outlet can be arranged on sides of the cooling plate that are located opposite one another. Depending on the installation situation, an optimal fluidic coupling of the channel structure, in particular to a coolant circuit, can thus be realised in a flexible manner.

According to another preferred embodiment, the cooling plate can have a rectangular geometry. In this embodiment, the coolant inlet and the coolant outlet are both arranged on a narrow side or both on a wide side of the cooling plate. A cooling plate formed in such a manner is a particularly compact construction and can thus also be integrated in a coolant circuit in a particularly space-saving manner.

Further, the invention includes a battery cell arrangement having multiple battery cells each comprising a battery cell housing, which for forming a stack of battery cells, are arranged spaced apart next to one another in a stack direction. The arrangement of the battery cells relative to one another is effected in such a manner that between two battery cells spaced apart in the stack direction an intermediate space is formed. According to the invention, a cooling frame according to the invention introduced above is arranged in at least one intermediate space. Preferably, one such cooling frame according to the invention each is preferably arranged in multiple—particularly preferably in all—intermediate spaces formed between the battery cells. The advantages of the cooling frame according to the invention explained above therefore apply also to the battery cell arrangement according to the invention.

According to a preferred embodiment of the battery cell arrangement, the at least one cooling frame lies flat against the battery cell or its battery cell housing adjacent both in the stack direction and also opposite to the stack direction. In this manner, a particularly effective thermal coupling of the cooling frame or of the cooling plate and thus of the coolant flowing through the respective channel structure provided is ensured.

According to an advantageous further development, a cooling frame each is preferentially arranged in all intermediate spaces formed between the battery cells along the stack direction, wherein the at least two coolant inlets of the individual cooling frames fluidically communicate with one another and the at least two coolant outlets of the individual cooling frames fluidically communicate with one another.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

### BRIEF DESCRIPTION OF THE DRAWINGS

Preferred exemplary embodiments of the invention are shown in the drawings and are explained in more detail in the following description, wherein same reference numbers relate to same or similar or functionally same components.

It shows, in each case schematically:

FIG. 1 an example of a cooling frame according to the invention in a perspective representation,

FIG. 2 the cooling frame of FIG. 1 with film arranged on the top side and on the bottom side each,

FIG. 3 an example of a battery cell arrangement according to the invention with multiple cooling frames according to FIG. 2 stacked on top of one another,

FIG. 4 a version of the cooling frame shown in FIG. 1 in a perspective representation,

FIG. 5a-5e greatly simplified and roughly schematically shown examples for possible contours of the channel structure formed in the cooling plate.

### DETAILED DESCRIPTION

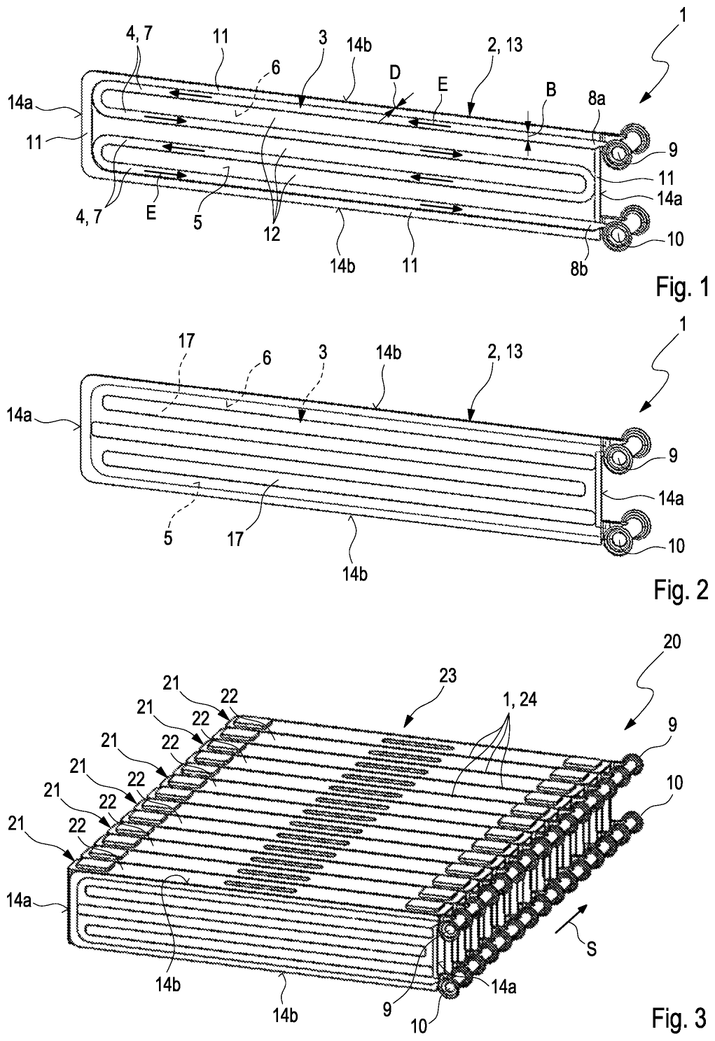

FIG. 1 shows in a perspective representation an example of a cooling frame 1 according to the invention for a battery cell arrangement 20 according to the invention. According to its designation, the cooling frame 1 is formed in the manner of a frame and includes a cooling plate 2 of a plastic, in which a channel structure 3 that can be flowed through by a coolant (not shown) is present. This channel structure 3 is realised in the example of FIG. 1 by a cut-out 4 formed in the cooling plate 2.

FIG. 2 shows a further development of FIG. 1. As illustrated by FIG. 2, a film 17 each, preferentially a multi-composite film of plastic and metal, can be arranged on or attached to a top side 5 of the cooling plate 2 and to a bottom side 6 of the cooling plate 2 located opposite to the top side 5. In the cooling plate 2, the cut-out 4 extends from the top side 5 to the bottom side 6. Here, the two films 17 cover the channel structurer 3 on the top side 5 and on the bottom side 6 respectively in a fluid-tight manner and in this way delimit the channel structure 3 or the cut-out 4 forming the channel structure 3 towards the top side 5 and the bottom side 6 of the cooling plate 2 respectively.

The cut-out 4 is formed longitudinally for forming a coolant channel 7 that can be flowed through by the coolant. The longitudinal cut-out 4 or the coolant channel 7 extends along an extension direction E. At a first extension end 8a of the longitudinal cut-out 4 or of the coolant channel 7, the same opens into a coolant inlet 9, via which the coolant can be conducted into the cut-out 4 or the coolant channel 7. At a second extension end 8b located opposite the first extension end 8a, the cut-out 4 or the coolant channel 7 opens into a coolant outlet 10, via which the coolant, having flowed through the coolant channel 7 or the cut-out 4, can be again conducted out of the same.

A width B of the cut-out 4 or of the coolant channel 7 measured transversely to the extension direction E amounts to maximally 6.5 mm, preferentially approximately 6.5 mm. In the example of the FIGS. 1 and 2, a plate thickness D of the cooling plate 2 is greater in the region of an outer edge zone 11 delimiting the cooling plate 2 laterally outside by at least 0.5 mm than in a laterally inner zone 12 of the cooling plate 2 complementarily to the said edge zone 11. For example, the plate thickness D in the region of the outer edge zone can amount to approximately 2.2 mm and in the region of the inner edge zone 12 to approximately 1.2 mm. In the example, the outer edge zone 11 completely surrounds the inner edge zone 12.

In the example of FIG. 1, the cut-out 4 and the channel structure 7 each have a meandering contour in a plan view of the top side 5 and of the bottom side 6 of the cooling plate 2. In the example of the FIGS. 1 and 2, the cooling plate 2 additionally has the geometry of a rectangle 13 with two narrow sides 14 located opposite one another and with two wide sides 14b located opposite one another.

In the example of the FIGS. 1 and 2, the coolant inlet 9 and the coolant outlet 10 are arranged on the same narrow side 14a. However, it is also conceivable to arrange the coolant inlet 9 and the coolant outlet 10 on the same wide side 14b (not shown). According to a further alternative, the coolant inlet 9 and the coolant outlet 10 can be arranged on narrow sides 14a located opposite one another and on wide sides 14b located opposite one another (not shown in the figures).

FIG. 3 shows exemplarily a battery cell arrangement 20 according to the invention with multiple cooling frames 1 exemplarily explained above. The arrangement 20 includes multiple battery cells 21 which generate waste heat during the operation. This waste heat is discharged with the help of the cooling frames 1 explained above. For this purpose, as already explained above, a coolant is conducted through the channel structure 3 provided in the cooling plates 2, to which coolant the (waste) heat generated by the battery cells 21 can be transferred. In this way, the battery cells 21 are cooled as desired.

Each of the battery cells 21 includes a respective battery cell housing 22. In the example of FIG. 3, the arrangement 20 includes multiple battery cells 21 and thus also multiple battery cell housings 22, which for forming a stack 23 are arranged next to one another along a stack direction S spaced apart from one another, so that between two battery cells 21 that are adjacent in the stack direction S an intermediate space 24 each is formed.

As is noticeable in FIG. 3, a cooling frame 1 is arranged in each of the intermediate spaces 24. Here, each cooling frame 1 lies flat against the battery housing 22 that is adjacent in the stack direction S and also against the battery cell housing 22 that is adjacent opposite to the stack direction S. In other words, the two battery cell housings 22 of two battery cells 21 delimiting a respective intermediate space 24 along the stack direction S lie flat against the top side 5 and the bottom side 6 respectively (not marked in FIG. 3) of the cooling plate 2 of the cooling frame 1 concerned arranged in the respective intermediate space 24. In this way, a particularly effective thermal coupling of the cooling plate 2 and thus also of the coolant flowing through the channel structure 3 to the battery cell housing 22 and battery cells 21 concerned is ensured.

As is additionally noticeable in FIG. 3, the coolant inlets 9 fluidically communicate with one another. Likewise, all coolant outlets 10 fluidically communicate with one another. Because of this, all cooling frames 1 of the battery cell arrangement 20 can be integrated in a coolant circuit (not shown in FIG. 3) in a simple manner.

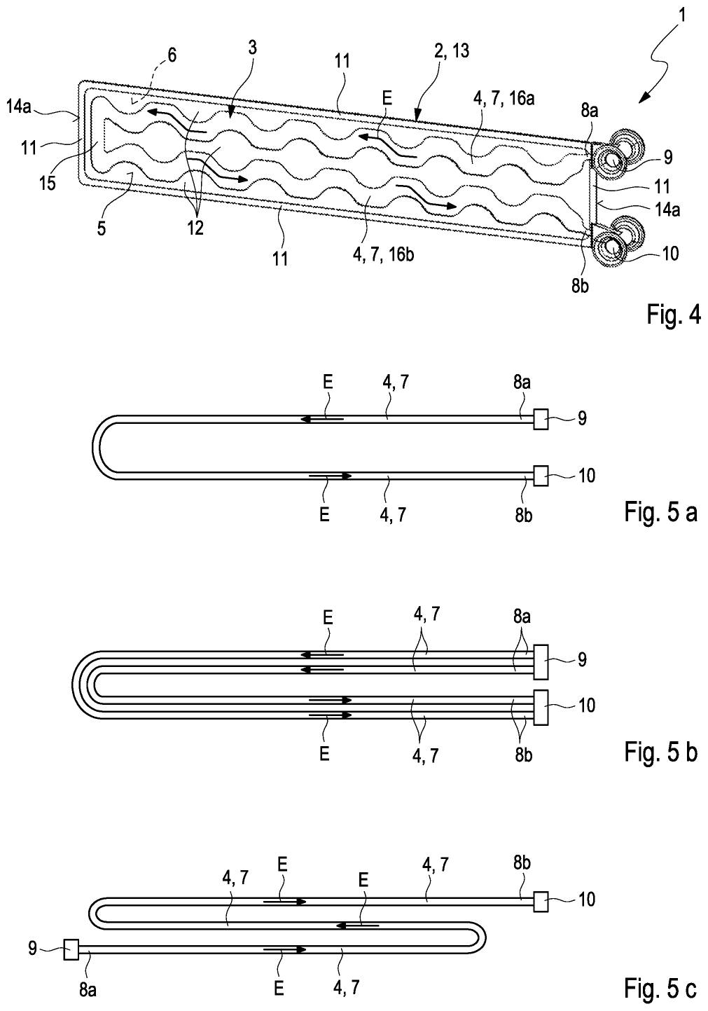

FIG. 4 illustrates a version of the cooling frame 1 of FIG. 1. In the example of FIG. 4, the cut-out 4 and the channel structure 7 has a U-shaped contour in a plan view of the top side 5 and the bottom side 6 respectively with a base 15 extending parallel to the narrow side 14a and with two legs 16a, 16b each extending parallel to the wide sides 14b. In addition to this, the cut-out 4 has, in a plan view of the top side 5 or of the bottom side 6 of the cooling plate 2 shown in FIG. 4, a wavy contour each in the region of the two legs 16a, 16b, i.e. in portions. In this way, a particularly homogeneous thermal contact of the coolant flowing through the cooling channel 7 with the battery cell housings 22 of the respective battery cells 21 to be cooled can be achieved.

It is to be understood that the cooling frame 1 shown in FIG. 4, just as the one of FIG. 1, can be used in the battery cell arrangement 20 according to FIG. 3. Obviously, a combined use of the cooling frame 1 according to the FIGS. 1 and 4 in the battery cell arrangement 20 of the FIG. 3 is also conceivable. It is to be understood in addition that the cooling frame 1 according to FIG. 4 can also be equipped with the further development provided in FIG. 2 in the form of a film 17 each arranged on the top side 5 and the bottom side 6 respectively, which cover the cooling plate 2 and thus also the cut-out 4 or the coolant channel 7 present in the cooling plate on the top and bottom sides.

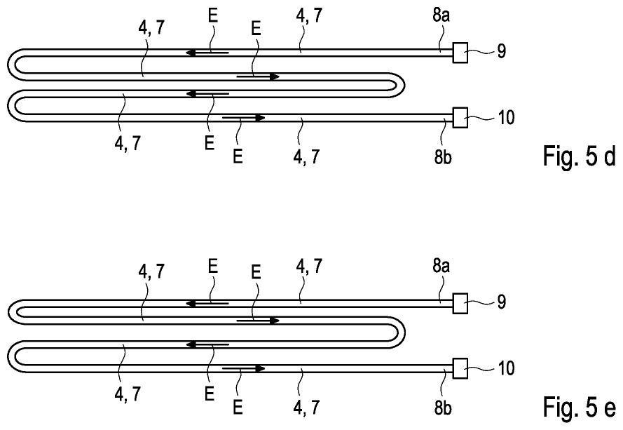

In the FIGS. 5a to 5e, different configuration versions of the cut-out 4 and of the channel structure 3 and of the coolant channel 7 each are shown. Purely exemplarily, the cooling plates 2 which, for the sake of clarity, are not shown in the FIGS. 5a to 5e can each have a rectangular geometry—analogous to the examples of the FIGS. 1 and 4—with two narrow sides 14a and with two wide sides 14b (not shown).

For the sake of clarity, FIG. 5a illustrates the U-shaped contour of the cut-out 4 and of the coolant channel 7 already explained by way of FIG. 4 only roughly schematically, however without wavy design of the two legs 16a, 16b of the U-shaped coolant channel 7 and cut-out 4 respectively.

FIG. 5b shows a further development of the example of 5a. In the example of the FIG. 5b, it is not only a single cut-out 4 and a single coolant channel 7 that is formed in the cooling plate 2 but two cut-outs 4 and coolant channels 7, which are arranged spaced apart from one another.

In the example of the FIG. 5b, the two cut-outs 4 or coolant channels 7 run parallel to one another but this is not mandatory. In the example of FIG. 5b, the said further development with two cut-outs 4 having the U-shaped geometry shown in FIG. 5a, is shown. Obviously, the provision of two cut-outs or coolant channels 7 for any contours of the cut-out 4 and the coolant channel 7 can be realised. It is likewise conceivable to also form more than two cut-outs 4 or coolant channels 7, in particular in the manner exemplarily shown in FIG. 5b.

In the example of the FIG. 5b, the two first extension ends 8a of the two cut-outs 4 or coolant channels 7 open into a common coolant inlet 9 only roughly schematically indicated in FIG. 5b. Likewise, the two second extension ends 8b of the two cut-outs 4 or coolant channels 7 open into a common coolant outlet 10 that is likewise only roughly schematically indicated.

FIG. 5c shows a version of the example of FIG. 5a. In the example of the FIG. 5c, the only shown cut-out 4 or coolant channel 7, in contrast for example with FIG. 5a, has an S-shaped contour. This means that the first extension end 8a and thus the coolant inlet 9 and the second extension end 8b and thus the coolant outlet 10 are arranged on sides located opposite one another.

It is to be understood that the example of FIG. 5c can be combined with the example of FIG. 5b. Likewise, the wavy contour shown in FIG. 4 can be provided in portions or completely in all shown examples.

1. A cooling frame for a battery cell arrangement, comprising:
a cooling plate including a channel structure that can be flowed through by a coolant and is formed by at least one cut-out provided in the cooling plate.

2. The cooling frame according to claim 1,
including a film arranged on a top side and a bottom side of the cooling plate respectively, the film covers the channel structure on the top side and on the bottom side in a fluid-tight manner.

3. The cooling frame according to claim 1, wherein:
the at least one cut-out is formed longitudinally for forming a coolant channel;
at a first extension end the at least one cut-out opens into a coolant inlet for conducting the coolant into the coolant channel; and
at a second extension end the at least one cut-out opens into a coolant outlet for conducting the coolant out of the coolant channel.

4. The cooling frame according to any one of the claim 3, wherein:
the at least one cut-out extends along an extension direction; and
a width of the at least one cut-out measured transversely to the extension direction amounts to maximally 6.5 mm.

5. The cooling frame according to claim 1, wherein:
a plate thickness of the cooling plate in an outer edge zone is greater by at least 0.5 mm than in an inner edge zone of the cooling plate that is complementary to an edge portion; and
the outer edge zone surrounds the inner edge zone completely.

6. The cooling frame according to claim 1,
wherein the at least one cut-out or the channel structure has, in a plan view of the cooling plate, a U-shaped, an S-shaped, or a meandering contour.

7. The cooling frame according to claim 1,
wherein the at least one cut-out or the channel structure has, in a plan view of the cooling plate, a wavy contour at least in portions.

8. The cooling frame according to claim 3,
wherein for forming a respective coolant channel, at least two cut-outs are arranged in the at least one cooling plate, which with their first extension ends open into the coolant inlet and with the second extension ends open into the coolant outlet.

9. The cooling frame according to claim 8, wherein:
the coolant inlet and the coolant outlet are arranged on a same side of the cooling plate; or
the coolant inlet and the coolant outlet are arranged on sides of the cooling plate located opposite one another.

10. The cooling frame according to claim 1,
wherein the cooling plate has a rectangular geometry with two narrow sides and with two wide sides, and wherein a coolant inlet and a coolant outlet are both arranged on one of the narrow sides or both on one of the wide sides of the cooling plate.

11. A battery cell arrangement, comprising:
multiple battery cells each including a battery cell housing, the multiple cells form a battery cell stack, and the multiple cells are arranged next to one another and spaced apart along a stack direction, wherein between two battery cells, arranged in the stack direction, an intermediate space is formed;
wherein in at least one intermediate space, a cooling frame according to claim 1 is arranged.

12. An arrangement according to claim 11,
wherein the at least one cooling frame lies flat against both the battery cell housing adjacent in the stack direction and also opposite to the stack direction.

13. The arrangement according to claim 11,
wherein in at least two of the intermediate spaces, a cooling frame is arranged, and wherein at least two coolant inlets fluidically communicate with one another and at least two coolant outlets fluidically communicate with one another.

14. The cooling frame according to claim 1, including a film attached to a top side and a bottom side of the cooling plate.

15. The cooling frame according to claim 3, wherein:
the at least one cut-out extends along an extension direction; and
a width of the at least one cut-out measured transversely to the extension direction amounts to approximately 6.5 mm.

16. The arrangement according to claim 11, wherein in each of the intermediate spaces, a cooling frame is arranged.

17. The arrangement according to claim 11, wherein the cooling frame includes a film.

18. The arrangement according to claim 17, wherein the film is attached to a top side and a bottom side of the cooling plate.

19. The arrangement according to claim 11, wherein the cooling frame includes at least one cut-out.

20. The arrangement according to claim 19, wherein:
the at least one cut-out is formed longitudinally for forming a coolant channel;
at a first extension end the at least one cut-out opens into a coolant inlet for conducting the coolant into the coolant channel; and
at a second extension end the at least one cut-out opens into a coolant outlet for conducting the coolant out of the coolant channel.
